(19) United States
(12) Patent Application Publication
(10) Pub. No.: US 2004/0111838 A1
(43) Pub. Date: Jun. 17, 2004

(54) Trigger extension for pneumatic gun

(76) Inventor: Candido Carl Menor, Wellington, NV (US)

Correspondence Address: DERGOSITS & NOAH LLP, Attn: Richard A. Nebb, Four Embarcadero Center, Suite 1450, San Francisco, CA, 94111, US

(21) Appl. No.: 10/322,560

(22) Filed: Dec. 17, 2002

(51) Int. Cl. B62B 1/00

(52) U.S. Cl. 16/427

(57) ABSTRACT

An extension device for trigger-actuated hand tools includes a longitudinal member having a handle with an actuation mechanism at one end thereof and a tool engaging portion at the other end thereof. A linkage couples the actuation mechanism to the trigger of the hand tool. The tool engaging portion can be adapted to engage a variety of tools and preferably includes a threaded screw fastener to secure the extension device to the tool. In a preferred embodiment, the longitudinal member is a hollow tubular member and the linkage is a spring-biased, unitary rod extending through the interior bore of the hollow tubular member.

### FIELD OF THE INVENTION

The present invention relates generally to an accessory for hand tools, such as pneumatic and electric tools, and more specifically to a extension piece with a trigger that provides user control of the tool at a specified distance from the tool itself.

### BACKGROUND OF THE INVENTION

There are a large variety of pneumatic and electric tools developed over the past 20 or more years that require the operator to remain in immediate proximity with the tool in order to operate the trigger, switch or other mechanism that actuates the tool. In many instances, this requires the operator to maintain awkward and/or uncomfortable body posture, such as on one's knees, for extended periods of time. Additionally, it is frequently desired to use such tools in a manner that does not allow the operator to maintain the customary hand contact that is required to effectively actuate the tool. For example, a nail gun that is used to install ceiling tiles would otherwise require a means of getting the operator closer to the ceiling (e.g., on a ladder, etc.) in order to actuate the gun and drive nails into the ceiling. While solutions to such problems of using pneumatic and electric tools do exist (such as rudimentary extension devices), there is currently the need to remedy various drawbacks associated with existing solutions.

For example, some extension devices provide only an extension that grips the tools itself, and do not allow for remote actuation of the trigger or other mechanism that operates the tool. These devices possess the drawback that the operator must always stay within a specific proximity of the tool so that they may turn it on and off in the conventional manner.

Another drawback of existing extension devices is that they are frequently heavy, bulky and otherwise too unwieldy for many desired applications. For example, most of such prior art devices require multiple hands to operate, even for use with tools that otherwise only require a single hand to operate normally. This presents the serious burden of inhibiting the other tasks that an operator would like to or must accomplish with his free hand, such as maintain difficult positioning, balance or performing tasks that facilitate the efficient completion of the job at hand.

Still other drawbacks of existing extension devices is that they oftentimes do not afford the flexibility and/or simplicity that is required to provide an accessory product that makes sense to both the consumers and the producers. Such extension devices are usually of a fixed nature, and are inflexible in adapting to a discrete number of positions that are most advantageous to the various required uses. Similarly, such devices generally fail to possess the simplicity and compactness that is desired, thereby placing the operator at a significant disadvantage.

Therefore, current extension devices are generally unable to offer the construction, usefulness, and flexibility required to adequately and cost-effectively provide the functionality desired by today's pneumatic and electric tool-using customers.

### SUMMARY OF THE INVENTION

An extension device for electric and pneumatic trigger-actuated hand tools comprising an extension piece, a handle having a tool actuation mechanism (trigger), a tool engaging portion, and linkage that translates a user action at the handle to the operating mechanism located on the tool itself is described. The tool-engaging portion is adapted to the particular tool that it is desired to operate, and may include, for example, a threaded screw fastener or a band structure to secure the tool therein. In one embodiment, the extension piece is comprised of a hollow tubular member, and the linkage comprises a unitary rod spring biased within the hollow tubular member and extending therethrough. In the presently preferred embodiment, the extension device may be set at multiple angles by means of discrete positioning means that allows a person to use the device with any tool for a large variety of applications.

Other features and advantages of the present invention will be apparent from the accompanying drawings and from detailed description that follows.

### BRIEF DESCRIPTION OF THE DRAWINGS

FIG. 1 illustrates a person using a tool extension device, according to one embodiment of the present invention;

FIG. 2 illustrates a close-up view of the left side of the tool extension device, shown attached to an exemplary tool, according to one embodiment of the present invention;

FIG. 3a illustrates a close-up view of the right side of the tool extension device, according to an embodiment of the present invention where the tool engaging portion is hinged and in an open (tool receiving) position;

FIG. 3b illustrates a close-up view of the right side of the tool extension device, according to an embodiment of the present invention where the tool engaging portion is hinged and in an closed (tool securing) position;

FIG. 4 illustrates a cross-section of the tool extension device, showing a unitary linkage member with fixed trigger structure, according to one embodiment of the present invention; and

FIG. 5 illustrates a cross-section of the tool extension device, showing a linkage member with moving trigger structure, according to one embodiment of the present invention;

### DESCRIPTION OF THE PREFERRED EMBODIMENTS

An extension device for electric and pneumatic trigger-actuated hand tools comprising an extension piece, a handle having a tool actuation mechanism (trigger), a tool engaging portion, and linkage that translates a user action at the handle to the operating mechanism located on the tool itself is disclosed. In the following description, for purposes of explanation, numerous specific details are set forth in order to provide an understanding of the present invention. It will be evident, however, to those of ordinary skill in the art that the present invention may be practiced without the specific details. In other instances, well-known structures and devices are shown in block diagram form to facilitate explanation. The description of preferred embodiments is not intended to limit the scope of the claims appended hereto.

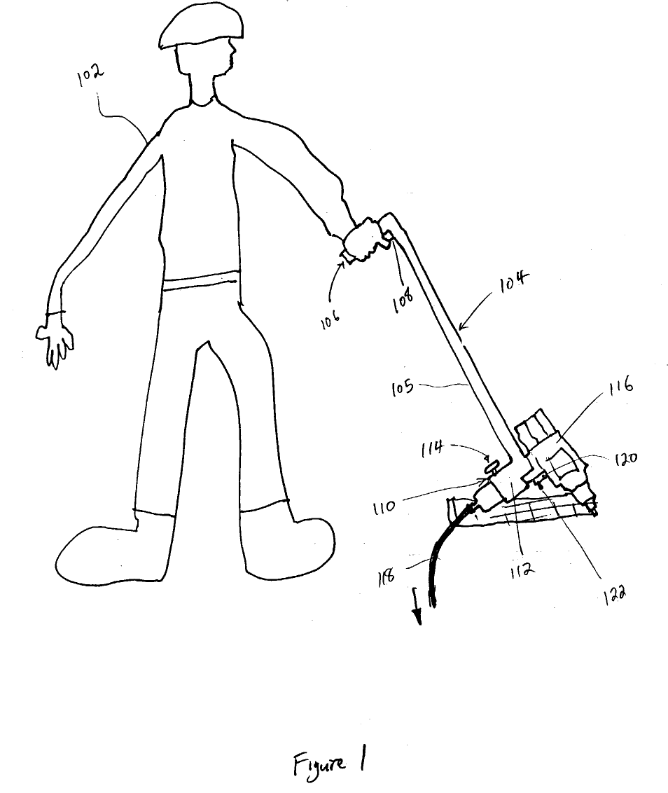

The typical operation of a contemplated tool extension device in shown in FIG. 1. FIG. 1 illustrates a person using a tool extension device that is constructed according to one preferred embodiment of the present invention. As seen in the figure, the tool operator or user 102 is shown holding an extension device 104 in one hand. The extension device 104 includes a first longitudinal extension member 105, a handgrip portion 106 and actuation mechanism 108 (such as a trigger) at one end, and a tool engaging portion 110 at the other end. In this embodiment, the tool engaging portion 110 is comprised of a tool-receiving cavity and a threaded knob 114 that is used to secure the tool 116 onto the extension device 104. The tool 116 shown in the embodiment of FIG. 1 is a pneumatic nail gun that is generally attached to a source of pressurized air by means of a hose 118; however, the invention disclosed herein is not limited to any particular tool or tools.

As seen in more general detail in the embodiment of FIG. 1, the tool 116 has an switch 120 (which could be a button, a trigger, an on/off switch or any other type of salient mechanism), which is actuated by the relative movement of a lever 122 extending from the tool end of the extension device 104. The lever 122 is connected to the actuation mechanism 108 by means of linkage (not shown in FIG. 1) that extends through the extension member 105, according to this preferred embodiment. During use, user action upon the actuation mechanism 108 (e.g. pulling the trigger) is translated by means of a linkage structure to the lever 122 located at the tool-receiving end of the extension device 104. As will be described in more detail below, the actuation mechanism 108, the lever 122 and/or the linkage can be spring biased so as to return the lever 122 to a non-actuating (non-triggering) position after a user action, thereby resetting the tool and extension device positioning for subsequent and repetitive use.

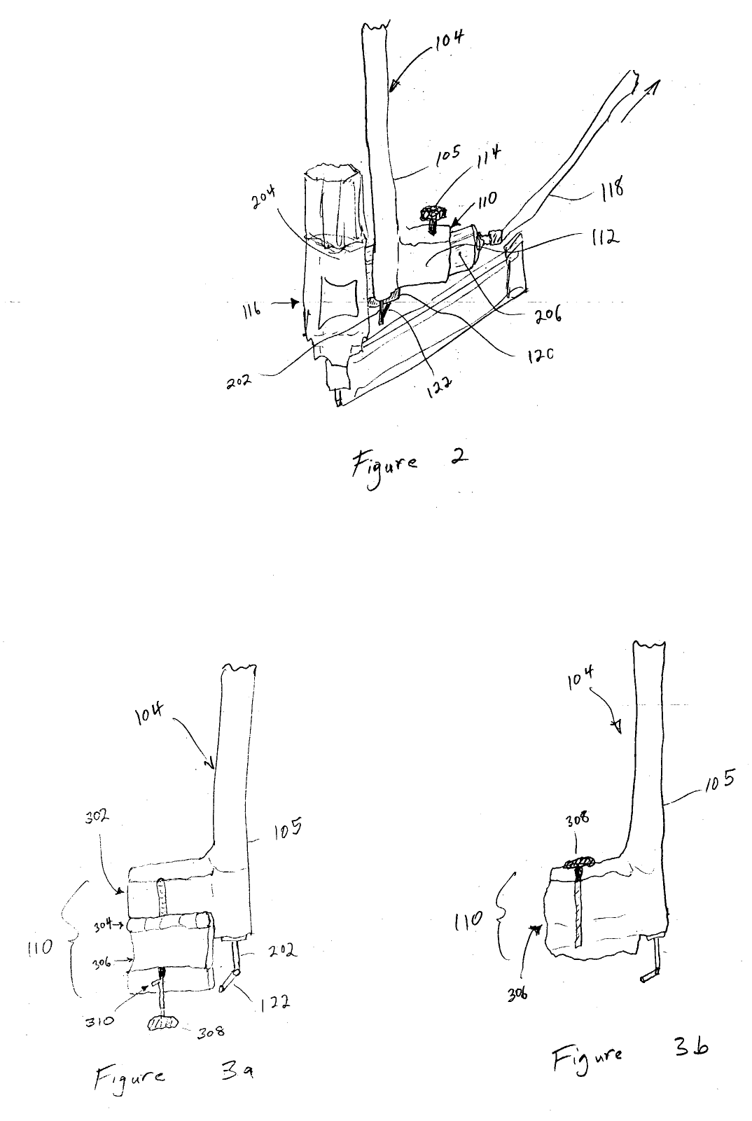

FIG. 2 illustrates a close-up view of a portion of the tool extension device 104, shown attached to an exemplary tool 116, according to one embodiment of the present invention. FIG. 2 shows greater detail of how the tool 116 may be secured to the extension device 104, and how the lever 122 can engage and operate the tool switch 120. With respect to the extension device 104, the detail of FIG. 2 depicts only the tool-side portion of the extension member 105, as well as the tool engaging portion 110, the threaded knob 114, an exposed portion of the linkage 202, and the lever 122. With respect to the illustrated tool, the detail of FIG. 2 depicts the tool body 204, the tool handle 206, the tool operating switch 120, and the pressurized air hose 118.

As is evident from the illustration of FIG. 2, the tool 116 can be secured to the extension device 104 by inserting the handle 206 within a complimentary-shaped tool-receiving cavity 112 and screwing an inward facing, threaded end (not shown) of the threaded knob 114 against an upper side of the tool handle 206. This screwing-in of the threaded knob 114 forces the tool handle against the lower (in this figure) bracket portion of the tool receiving cavity 112, thereby securing the tool 116 to the extension device 104.

This tool-receiving cavity 112 and threaded knob 114 combination is one form of the securing device set forth in this specification, however many other securing devices are contemplated. For example, as described below in connection with FIG. 3a, a preferred embodiment that is a modification of the above securing device incorporates a two-piece or hinged tool-receiving cavity. As shown in the figure, the tool engaging portion flips open and closed to accept and surround the tool handle, with a similar threaded knob on the hinged portion being used to secure the tool. Furthermore, the securing device might also take the form of a band having some type of a clip or a screw-together clasp that is used to tighten the band around the tool handle. Similarly, the securing device could take the form of cavity that snaps tightly closed or structure that is twisted in such a manner as to lock the handle tightly in place. In sum, the securing device can take the shape of many known mechanical coupling devices that provide a firm connection between the extension device 104 and the tool 116. Depending upon the tool itself, the securing device can secure the tool by connection to some part of the subject tool, and is not limited to attachment to the tool handle alone.

FIG. 3a illustrates a close-up view of the right side of the tool extension device, according to an alternate embodiment of the present invention where the tool engaging portion is hinged and in an open (tool receiving) position. The extension device 104 is shown in FIG. 3a such that the tool side of the extension member 104 and the exposed tool engaging portion 110 are readily seen, according to this preferred embodiment. The tool engaging portion 110 is composed of a first portion 302 that is fixed to the extension member 104, a hinge 304, a second portion 306 that is rotatably attached to the hinge 304, and a threaded knob 308 having a plunger/coupling end portion 310. Also shown in this view are the exposed part of the linkage portion 202, and the lever 122.

FIG. 3b illustrates a close-up view of the right side of the tool extension device, according to this alternate embodiment of the present invention where the tool engaging portion is hinged and in an closed (tool securing) position. From this ‘closed’ arrangement, the backside of the second portion 304 discussed above in connection with FIG. 3a is the primary structure that can be seen of the tool engaging portion 110. As can be seen from the Figure, the threaded knob 308 is now located on top (in this view) of the tool engaging portion 110, as it has been rotated upward along with the second portion 304 via the hinge (not shown).

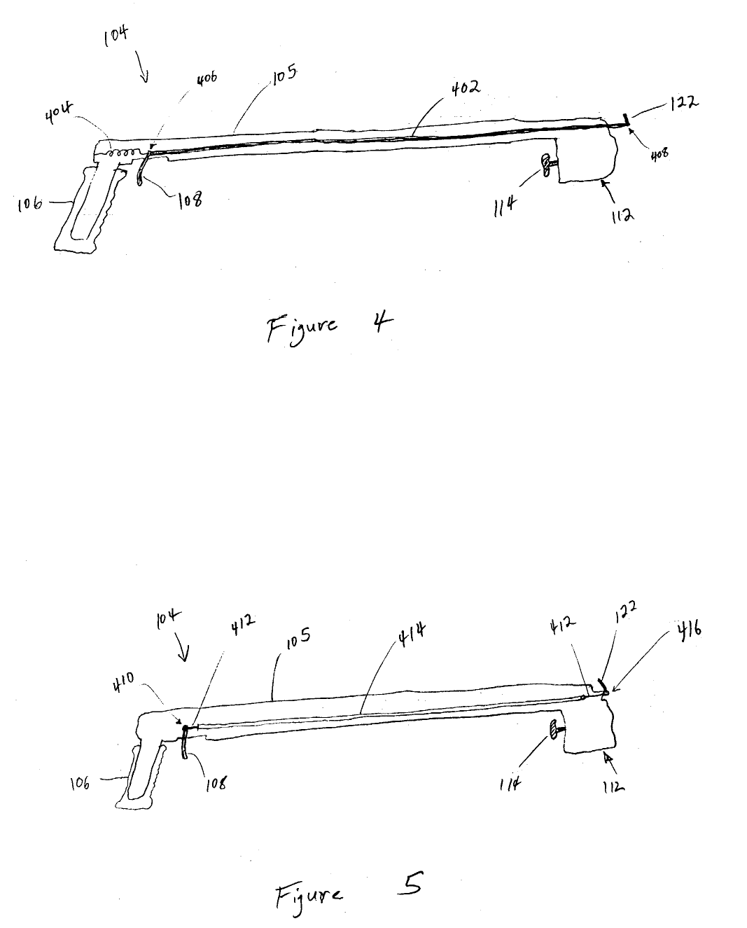

FIG. 4 illustrates a cross-section of the tool extension device, showing a unitary linkage member with fixed trigger structure, according to one embodiment of the present invention. In this embodiment, the basic parts of the extension device 104 are shown in cross-section, including the handle portion 106, the extension member 105, the tool engaging portion 112, and the threaded knob 114. The interior of the extension member 105 depicts the preferred elements of a linkage portion that connects the actuation mechanism 108 with the lever 122. In should be noted that, although this and other embodiments illustrate the linkage portion located on the interior of the extension member 105, the present invention contemplates any location of the linkage elements with respect to the extension member 105, such as external thereto, or a combination of external and internal components.

The linkage portion illustrated in the embodiment of FIG. 4 is comprised of a unitary rod 402 and a spring biasing member 404. The spring biasing member 404 can be any type of spring or biasing device that either exerts a pushing or pulling force on the unitary rod 402 so as to keep it in a “set” position allowing continuous and repetitive actuation of the tool. In this regard, the spring biasing member 404 can be attached to any part of the extension device 104 that provides such bias. This unitary linkage embodiment is characterized by a particularly simple construction that has both the actuation mechanism 108 and the lever 122 permanently affixed to either end of the unitary rod 402. This unitary structure affords significant advantage, in terms of desirability, reliability and ease-of-construction, over known extension devices.

FIG. 5 illustrates a cross-section of the tool extension device, showing a linkage member with a moving trigger structure, according to one embodiment of the present invention. This illustration shows most of the same elements of the extension device 104 from FIG. 4 without change, specifically, the handle portion 106, the extension member 105, the tool engaging portion 112 and the threaded knob 114. However, the embodiment of FIG. 5 shows a linkage portion that is comprised of an actuation mechanism 108 situated at a set rotation point 410, a lever 122 situated at a lever rotation point 416, and moving linkage connecting the two rotation points. It is noted that this embodiment is shown for purposes of illustration and not limitation, as many known moving linkages are contemplated within the scope of the present invention.

The contemplated moving linkage(s) can be implemented, as shown in FIG. 5, by means of a cable 412 and a cable sleeve 414. In such embodiments, the cable 412 is connected to either the actuation mechanism 108 itself or to a gear mechanism (such as those found in conventional bicycle brake lines) such that operation of the actuation mechanism 108 causes the cable to be drawn in a direction either away from or into the fixed cable sleeve 414. The relative motion on the cable is either translated directly through the cable sleeve, or indirectly by means of more complicated linkage, to the tool-receiving end of the extension device. At the tool receiving end, the cable 412 exits the cable sleeve 414 and provides relative motion to the lever 122 in order to operate the trigger of the pneumatic or electric tool. This relative motion is provided in the complimentary fashion as the relative motion that was delivered by the user's hand.

In the foregoing, a device has been described for providing an extension of reach and actuation for hand tools, particularly pneumatic or electric tools. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense

What is claimed is:

1. An extension device for a hand tool having a trigger mechanism, comprising a longitudinal extension member having a linkage coupled thereto adapted for longitudinal movement, said extension member further including a first end having an actuator coupled to impart longitudinal movement to the linkage upon user action, and a second end having a driver for translating the longitudinal movement to operate upon the trigger mechanism, and a coupler for securely fixing the extension member to the hand tool.

2. An extension device for a hand-operated tool having a trigger mechanism, comprising:
a first longitudinal member;
a handgrip portion located at a first end of the first longitudinal member and including an actuation mechanism;
a tool engaging portion located at a second end of the first longitudinal member and including a securing mechanism for securing the tool to the extension device; and
a linkage portion coupling the actuation mechanism to the trigger mechanism, wherein user action upon the actuation mechanism is translated via the linkage portion to operate the trigger mechanism.

3. The extension device of claim 2, wherein the first longitudinal member consists of a hollow tubular member, and the linkage portion extends through the hollow portion of the first longitudinal member.

4. The extension device of claim 3, wherein the linkage member is comprised of a unitary member that directly translates user action of the actuation mechanism to the tool trigger, the actuation mechanism is attached to the linkage portion in a fixed relationship, and the linkage portion includes a fixed piece, which is complimentary to the actuation mechanism, that is located at the tool engaging end and operates the trigger mechanism when the actuation mechanism is actuated.

5. The extension device of claim 4, further including a biasing device for biasing the unitary member toward a non-actuated position.

6. The extension device of claim 5, wherein the biasing device is a spring attached to the handgrip portion.

7. The extension device of claim 2, wherein the securing mechanism comprises a tool-receiving cavity and a clamping device.

8. The extension device of claim 7, wherein the clamping device comprises a tool clamping portion in threaded engagement with the tool engaging portion, and a knob used to screw in the tool clamping portion so as to secure the tool.

9. The extension device of claim 2, wherein the securing mechanism comprises a band that encircles part of the tool and a securing portion to fasten the band around the tool thereby securing the tool.

10. An extension device for a hand-operated tool having a trigger mechanism, comprising:
a hollow tubular member having a handgrip portion at a first end thereof and a tool engaging portion at a second end thereof; wherein the handgrip portion includes an actuation mechanism;
a linkage coupling the actuation mechanism to the trigger mechanism, wherein user action upon the actuation mechanism is translated via the linkage to operate the trigger mechanism.
